(19) United States
(12) Patent Application Publication
(10) Pub. No.: US 2015/0192234 A1
(43) Pub. Date: Jul. 9, 2015

(54) MAGNETIC AUTHENTICATION

(71) Applicant: ORIDION MEDICAL 1987 LTD., Jerusalem (IL)

(72) Inventors: Tim Fries, Louisville, CO (US); Paul Von Der Lippe, Loveland, CO (US); Wanran Ma, Boulder, CO (US)

(73) Assignee: ORIDION MEDICAL 1987 LTD., Jerusalem (IL)

(21) Appl. No.: 14/148,677

(22) Filed: Jan. 6, 2014

(51) Int. Cl. F16L 37/00

(52) U.S. Cl. CPC F16L 37/004

(57) ABSTRACT

The present disclosure provides a tube connector, including at least one magnet, arranged such that a tube connection system can identify at least one parameter of the magnet.

### TECHNICAL FIELD

The present disclosure relates generally to connectors and systems configured to identify the connectors.

### BACKGROUND DISCLOSURE

Analyzing devices, such as medical devices, use various types of connectors. Such connectors are used as mediators for connecting between the medical device interface (the instruments itself) and constituents, such as tubes, cannulas, pulse oximeter probes, Electrocardiography (ECG) or Electroencephalography (EEG) electrodes, non-invasive blood pressure (NIBP) Cuffs and other elements.

### SUMMARY

The present disclosure relates to tube connecters including a magnet(s) arranged such that a tube connection system can identify a parameter(s) of the magnet(s).

The connectors of the present disclosure may for example be used in a respiratory gas sampling and/or delivery tubing systems. Such connectors are typically located at a distal end of a sampling line and are configured to connect a sampling tube to a fluid analyzer, such as a gas analyzer, for example a capnograph.

The connectors of the present disclosure include at least one magnet which enables identification of the connectors. Accurate identification of the connector may be of uttermost importance for ensuring correct connection between a medical device and its constituents such as tubes, probes etc. The constituents are often of the disposable type, are frequently replaced and may require abrupt connection for example in emergency situations. To avoid sometimes fatal misconnections as well as optimal functioning of the instrument, it can be necessary to ensure that the medical device is only activated when a correct tube is properly connected and authenticated.

The connectors of the present disclosure may be configured to ensure that a medical device be activated only when a correct connector is properly connected. Similarly, the connector may be configured to ensure that a medical device is deactivated when the connector is withdrawn. This may prevent operation of a medical device when no constituent is connected or even when a correct constituent is improperly connected, thereby reducing damage to sensitive parts of the instrument as well as incorrect readings.

According to certain aspects of the disclosure, the magnetic parameters of the connectors described herein may also serve to enable identification of the connector (and consequently the tube or other constituent attached thereto) as belonging to one of a number of classes. Such identification may enable the medical instrument to automatically operate as appropriate for the identified connector.

The tube connectors described herein may further assist the medical personnel in connecting the connector to the medical device, which may proof to be of particular importance especially in emergency situations.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

According to some embodiments, there is provided a tube connector, having at least one magnet, wherein the at least one magnet is arranged such that a tube connection system can identify at least one parameter of the at least one magnet.

According to some embodiments, the at least one parameter is selected from the group consisting of inductance, flux, strength of magnetic field and polarity. Each possibility is a separate embodiment.

According to some embodiments, the at least one magnet may be attached to, embedded in or molded on an outer wall of the tube connecter.

According to some embodiments, the tube connector comprises at least two magnets. The at least two magnets may be identical or different and be arranged in a same or different circumferential axis of the connecter and in a same or different longitudinal axis of the connecter.

According to some embodiments, the tube connection system may be configured to identify recurring changes in the at least one parameter during the insertion of the tube connector into a tube connector receptacle. Additionally or alternatively, the tube connection system may be configured to identify recurring changes in the at least one parameter during the revolving of the tube connector relative to the tube connector receptacle.

According to some embodiments, the at least one parameter of said at least one magnet may be indicative of a type of the tube connector. Additionally or alternatively, the at least one magnet may be indicative of a preferred mode of operation of the tube connector.

According to some embodiments, the connector may be configured to connect to a medical device. According to some embodiments, when the at least one parameter is identified, the medical device is actuated optionally in a preferred mode of operation.

According to some embodiments, the at least one magnet eases proper connection of the connecter to the medical device.

According to some embodiments, the connecter may be attached to a fluid sampling tube.

According to some embodiments, there is provided a method comprising forming a tube connector; and applying at least one magnet onto the tube connector, such that a tube connection system can identify at least one parameter of the at least one magnet. According to some embodiments, applying the at least one magnet includes applying at least two magnets on same or different circumferential and/or longitudinal axes of the tube connector.

According to some embodiments, applying includes attaching, molding and embedding the magnet onto the connector.

According to some embodiments, the at least one magnet is applied on an outer wall of the tube connector.

### BRIEF DESCRIPTION OF THE DRAWINGS

Examples illustrative of embodiments are described below with reference to figures attached hereto. In the figures, identical structures, elements or parts that appear in more than one figure are generally labeled with a same numeral in all the figures in which they appear. Alternatively, elements or parts that appear in more than one figure may be labeled with different numerals in the different figures in which they appear. Dimensions of components and features shown in the figures are generally chosen for convenience and clarity of presentation and are not necessarily shown in scale. The figures are listed below.

FIG. 1 schematically illustrates a perspective view of an exemplary tube connector, according to some embodiments;

FIG. 2A schematically illustrates a perspective view of a tube connector receptacle according to some embodiments;

FIG. 2B schematically illustrates a perspective view of a tube connector receptacle according to some embodiments;

FIG. 3A schematically illustrates a cross-section view of a tube connector, such as the tube connector of FIG. 1, inserted into a receptacle coil, such as the receptacle coil of FIG. 2A, according to some embodiments;

FIG. 3B schematically illustrates a cross-section view of a tube connector, such as the tube connector of FIG. 1, inserted into a receptacle coil, such as the receptacle coil of FIG. 2B, according to some embodiments;

FIG. 4A schematically illustrates a perspective view of a tube connector having one magnet on an outer wall thereof, according to some embodiments;

FIG. 4B schematically illustrates a perspective view of a tube connector having one magnet on an outer wall thereof, according to some embodiments;

FIG. 4C schematically illustrates a perspective view of a tube connector having one magnet on an outer wall thereof, according to some embodiments;

FIG. 4D schematically illustrates a perspective view of a tube connector having one magnet on an end face thereof, according to some embodiments;

FIG. 5A schematically illustrates perspective views of a tube connector having two magnets, according to some embodiments;

FIG. 5B schematically illustrates perspective views of a tube connector having two magnets, according to some embodiments;

FIG. 5C schematically illustrates perspective views of a tube connector having two magnets, according to some embodiments;

FIG. 5D schematically illustrates perspective views of a tube connector having two magnets, according to some embodiments;

FIG. 5E schematically illustrates a perspective view of a tube connector having two magnets, according to some embodiments;

FIG. 6 schematically illustrates a perspective view of a connector having a magnet disposed on an outer wall thereof and a block diagram of a tube connection system, according to some embodiments;

FIG. 7 is an illustrative flowchart of identification of a tube connector, according to some embodiments.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

The present disclosure relates to tube connecters including a magnet(s) arranged such that a tube connection system can identify a parameter(s) of the magnet(s).

According to some embodiments, there is provided a tube connector, comprising at least one magnet, wherein the at least one magnet is arranged such that a tube connection system can identify at least one parameter of the at least one magnet.

As used herein, the term “tube connector” refers to a connector configured to connect between a tube, such as for example a sampling tube and a medical device (for example a gas analyzer). Alternatively or additionally, the connector can also be used for connecting any other element such as, but not limited to, cannulas, pulse oximeter probes, Electrocardiography (ECG) or Electroencephalography (EEG) electrodes, non-invasive blood pressure (NIBP) Cuffs and the like, to a medical device. The tube connector may be a radial connector, for instance a luer connector, such as a female and/or male luer connector. However other connectors, such as non-radial push-in connectors also fall under the scope of the disclosure.

As used herein, the terms “tube” unless specifically indicated otherwise, may interchangeably refer to, sample tubes, supply tubes, electrodes, probes, cables or any other suitable element configured to be connected to a medical device.

According to some embodiments, the at least one magnet is arranged such that that a tube connection system can identify a change in the at least one parameter during (or after) insertion of the tube connector into a tube connector receptacle. Additionally or alternatively, the at least one magnet is arranged such that that a tube connection system can identify a change in the at least one parameter during the revolving of the tube connector relative to a tube connector receptacle.

As used herein, the terms “tube connecter receptacle” and “receptacle” can be interchangeably used and refer to a device connector configured to receive the tube connector.

As used herein, the term “magnet” refers to a material or object having a magnetic field. This magnetic field is typically determines the force that pulls other ferromagnetic materials, such as iron, and attracts or repels other magnets.

According to some embodiments, the at least one magnet may be a permanent magnet. According to some embodiments, the term “permanent magnet” may refer to an object made from a material that is magnetized (ferromagnetic material) and creates its own persistent magnetic field. According to some embodiments, the magnet is made of any one of iron, nickel, cobalt, alloys of rare earth metals or naturally occurring minerals such as lodestone, or any combination thereof.

According to some embodiments, the at least one magnet may be an induced magnet. According to some embodiments, the term “induced magnet” may refer to electromagnets made from a coil of wire that acts as a magnet when an electric current passes through it, but stops being a magnet when the current stops. According to some embodiments, the coil may be wrapped around a core of soft ferromagnetic material such as steel, which enhances the magnetic field produced by the coil.

According to some embodiments, the at least one magnet may be attached to, embedded in or molded on an outer or an inner wall of the tube connecter. According to some embodiments, the at least one magnet may be located such that the magnetic field of the at least one magnet is perpendicular to a main axis (insertion axis) of the connector. According to some embodiments, the at least one magnet may be located such that the magnetic field of the at least one magnet is parallel to the main axis of the connector. According to some embodiments, the at least one magnet may be attached to, embedded in or molded on an end face of the tube connecter.

As used herein, the term “at least one magnet” may refer to 1, 2, 3, 4, 5, or more magnets. Each possibility is a separate embodiment. According to one non-limiting example, the tube connector comprises at least two magnets. According to some embodiments, the at least two magnets are identical. According to some embodiments, the at least two magnets are different from each other. According to some embodiments, the at least two magnets are arranged in a same circumferential axis on the connecter. According to some embodiments, the at least two magnets are arranged in a different circumferential axis on the connecter. According to some embodiments, the at least two magnets are arranged in a same longitudinal axis on the connecter. According to some embodiments, the at least two magnets are arranged in a different longitudinal axis on the connecter. According to another non-limiting example, the connector comprises three or more magnets. It is understood that the three or more magnets may all be similar. Alternatively the at least three magnets may differ for example in the strength of their magnetic field. Alternatively some of the magnets may be similar and some unique.

According to some embodiments, the connector comprises a plurality of magnets. As used herein the term “plurality” refers to 3 or more magnets for example, 5 or more magnets, 10 or more magnets, any number there between or any other suitable number of magnets. Each possibility is a separate embodiment.

As used herein, the terms “parameter”, “characteristic” and “property” with regards to a magnet refer to any parameter of the magnet, which may be detected, measured and/or quantified by any component and/or device known in the art to be suitable for this purpose. According to some embodiments, the at least one parameter may generate a ‘magnetic fingerprint’ that may allow a high-resolution distinction between different tube connectors and/or different classes of tube connectors.

As referred to herein the term “type”, “model”, “class” of the connector may interchangeably be used and may relate to the interface to be used with the tube connector.

According to some embodiments, the at least one parameter of the at least one magnet may be inherent to the magnet, such as its strength. Additionally or alternatively, the at least one parameter may be an induced parameter, generated when the connector bearing the magnet is inserted into a tube connecter receptacle, such as for example a tube connector receptacle comprising at least one coil.

According to some embodiments, the at least one parameter may be static. According to some embodiments, the at least one parameter may be dynamic such that a change in the at least one parameters occurs during the insertion of the tube connector into the tube connector receptacle.

According to some embodiments, the at least one parameter is selected from the group consisting of inductance, flux, strength of magnetic field and polarity. Each possibility is a separate embodiment.

According to some embodiments, the at least one magnet on the connector may be configured to induce an electromagnetic field (EMF) when the connector is inserted into the tube connector receptacle. According to some embodiments, the at least one magnet on the connector may be configured to generate a current when the connector is inserted into the tube connector receptacle.

According to some embodiment, the at least one magnet may be configured to change the strength and/or direction of an induced magnetic field such as for example the magnetic field induced by an electric current running through a coil such as a solenoid coil. For example, insertion of a connector bearing a magnet into a tube connector receptacle comprising a coil with an induced electromagnetic field of opposite direction, will reduce strength of the magnetic field and possibly even revert the direction of the magnetic field. For example, insertion of a connector bearing two magnets into a tube connector receptacle having a coil may initially generate a certain EMF as the first magnet is exposed to the coil. Upon further insertion of the connector, the EMF may then change as the second magnet is exposed to the coil of the receptacle. According to some embodiments, the at least one parameter of the at least one magnet may be indicative of a type of the tube connector. According to some embodiments, the at least one parameter of the at least one magnet may be indicative of a preferred mode of operation of the tube connector. According to some embodiments, a change in the at least one parameter during insertion of the tube connector into the tube connector receptacle may be indicative of a type of the tube connector. According to some embodiments, a change in the at least one parameter during insertion of the tube connector into the tube connector receptacle may be indicative of a preferred mode of operation of the tube connector. According to some embodiments, a change in the at least one parameter during revolving of the tube connector relative to the tube connector receptacle may be indicative of a type of the tube connector. According to some embodiments, a change in the at least one parameter during relative revolving of the tube connector and the tube connector receptacle may be indicative of a preferred mode of operation of the tube connector.

According to some embodiments, the connector may be configured to connect to a medical device. According to some embodiments, the medical device is a capnograph.

According to some embodiments, when the at least one parameter and/or the change therein is identified, the medical device may be actuated. According to some embodiments, when said at least one parameter and/or the change therein is identified, the medical device may be actuated in a preferred mode of operation. According to some embodiments, when the at least one parameter and/or the change therein is identified, the medical device may be deactivated.

According to some embodiments, the at least one magnet eases proper connection of the connecter to the medical device. It is understood by one of ordinary skill in the art that the magnetic properties of the at least one magnet may be utilized to create an attraction between the device connector and the tube connector receptacle thereby ease the insertion of the connector into the receptacle.

According to some embodiments, the tube connector further comprises ribs configured to secure the connector in the matching receptacle and/or to avoid direct contact between the at least one magnet and the receptacle. According to some embodiments, the ribs may be an integral part of the tube connector. Alternatively, the ribs may be molded on or otherwise attached to the tube connector.

According to some embodiments, the connecter may be attached to a fluid sampling tube. According to some embodiments, the tube connector comprises an inner channel adapted to transport or contain fluids. In some embodiments, the tube connector comprises a tube, optionally a fluid sampling tube. Each possibility is a separate embodiment.

According to some embodiments, there is provided a tube connection system configured to identify at least one parameter of at least one magnet positioned on (or otherwise attached to) a tube connector. According to some embodiments, the tube connection system may be configured to identify recurring changes in the at least one parameter during insertion of the tube connector into a tube connector receptacle. Additionally or alternatively, the tube connection system may be configured to identify recurring changes in the at least one parameter during the revolving of the tube connector relative to the tube connector receptacle.

According to some embodiments, the tube connection system comprises at least one detector configured to detect the at least one parameter of the at least one magnet on the tube connector. According some embodiments, the at least one detector is selected from the group consisting of: a galvanometer, magnetometer, gauss meter, voltmeter, ammeter and combinations thereof. Each possibility is a separate embodiment.

According to some embodiment, the tube connection system may be configured to identify the presence/absence of a connector based on the identification of the least one parameter of the at least one magnet. According to some embodiment, the tube connection system may be configured to identify the presence/absence of a connector based on the identification of a change in the least one parameter during insertion of the tube connector into the tube connector receptacle.

According to some embodiments, the tube connection system may be further configured to identify the tube as belonging to a certain class based on the at least one parameter and/or changes therein. According to some embodiments, the tube connection system may be further configured to distinguish between different classes of tube connectors. As a non-limiting example, the tube connector may be configured to identify a tube connector attached to a sampling tube adapted for use with infants and to distinguish between this connector and a connecter attached to a sampling tube adapted for use in adults.

According to the some embodiment, the tube connection system may be configured to generate at least one signal based on the at least one identified parameter. According to some embodiments, the at least one signal generated may serve as a trigger to activate/deactivate a medical device. Alternatively or additionally, the at least one signal may serve to influence an operation mode of the medical device.

According to some embodiments, the tube connection system comprises a tube connector receptacle. According to some embodiments, the receptacle comprises at least one coil. As used herein, the term “at least one coil” may refer to 1, 2, 3, 4, 5 or more coils. Each possibility is a separate embodiment.

According to some embodiments, the at least one coil may be a wire wound around a hollow core. According to some embodiments, the number of turns of the wire around the hollow core may be identical in each of the at least one coils. According to some embodiments, the number of turns of the wire around the hollow core may be different in each of, or in some of the at least one coil.

According to some embodiments the at least one coil may be a solenoid coil. According to some embodiments, the at least one magnet of the tube connector may be configured to induce a current and an electromagnetic field (EMF) in the at least one coil when the connector is inserted into the tube connector receptacle. According to some embodiment, the tube connection system may be configured to detect the current and/or EMF in the at least one coil. According to some embodiment, the tube connection system may be configured to detect a change in the current and/or the EMF in the at least one coil, during insertion of the tube connector into the tube connector receptacle. According to some embodiment, the tube connection system may be configured to detect a change in the current and/or the EMF in the at least one coil, during the revolving of the tube connector relative to the tube connector receptacle. According to some embodiments the tube connection system may be configured to identify the connector based on the detected current, EMF and/or change therein. According to some embodiment, the tube connection system may be configured to detect the direction of the current and/or the orientation of the induced EMF. According to some embodiment, the tube connection system may be configured to detect a change in the direction of the current and/or the orientation of the induced EMF during insertion of the tube connector into the tube connector receptacle. According to some embodiment, the tube connection system may be configured to detect a change in the direction of the current and/or the orientation of the induced EMF during revolving of the tube connector relative to the tube connector receptacle. According to some embodiment, the tube connection system may be configured to identify the connector based on the detected direction of the current, the orientation of the induced EMF and/or changes therein.

According to some embodiments, the inductance generated in the at least one coil of a tube connector receptacle depends on the orientation of the magnet. If, for example, the tube connector includes a magnet(s) positioned such that the magnetic moment of the magnet(s) is parallel to the main axis (insertion axis) of the connector, inserting the connector will cause (maximum) inductance in the coil of the receptacle. If on the contrary the magnetic moment of the magnet is perpendicular to the insertion axis, inserting the connector relative to the receptacle will not induce a current in the coil of the receptacle. It is further understood that if the magnetic moment of the magnet is oriented in an angle between 0-90° relative to the insertion axis a current of lesser magnitude than the maximum current will be induced. Suitable angles include but are not limited to 10, 20, 45, 60° relative to the insertion axis as well as any other suitable angle in the range of 0-90° relative to the insertion axis. Each possibility is a separate embodiment.

It is further understood that the induction in the at least one coil depends on the speed of insertion of the magnet. According to some embodiments, the tube connector receptacle may include insertion speed unifiers configured to level out the insertion speed of the tube connector into a tube connector receptacle. According to some embodiments, suitable insertion speed unifiers may include threads, indents, ribs or any other elements on the tube connector or in the tube connector receptacle configured to generate a uniform insertion speed of the connector into the tube connector receptacle even when used by different users.

According to some embodiments, when a radial connector is inserted into a tube connector receptacle including at least one coil, it may be necessary to revolve the connector relative to the receptacle in order for the connector to firmly connect. In such cases, revolving of the connector may also cause inductance in the coil. For example if the tube connector includes a magnet(s) positioned such that the magnetic moment of the magnet(s) is perpendicular to the main axis (insertion axis) of the connector, revolving the connector will cause (maximum) inductance in the coil of the receptacle. If on the contrary the magnetic moment of the magnet is parallel to the insertion axis, revolving of the connector relative to the receptacle will not induce a current in the coil of the receptacle. It is understood by the skilled in the art that if the magnetic moment of the magnet is oriented in any angle between 0-90° relative to the insertion axis a current of a magnitude less than maximum will be induced when the tube connector is revolved relative to the tube connector receptacle.

It is further understood that the induction in the at least one coil depends on the speed of the revolving of the tube connector relative to the receptacle. According to some embodiments, the tube connector receptacle may include insertion speed unifiers configured to level out the speed of revolving the tube connector relative to the tube connector receptacle. According to some embodiments, suitable revolving speed unifiers may include threads, indents, ribs or any other elements, on the tube connector or in the receptacle, configured to generate a uniform revolving speed even when used by different users. According to some embodiments, the insertion speed unifiers and the revolving speed unifiers may be the same elements on the tube connector or receptacle. According to some embodiments, different elements on either the tube connector or the receptacle serve as insertion speed unifiers and revolving speed unifiers.

It is understood by the skilled in the art that the direction of the current induced when the connector is withdrawn is opposite to the direction of the current when the connector is inserted. Hence, according to some embodiments, the tube connection system may be configured to actuate the medical device when an EMF of a certain direction is identified (indicating the insertion of the tube connector in to the receptacle) and to deactivate the device when an EMF of an opposite direction is identified (indicating that the tube connector has been withdrawn/disconnected from the receptacle).

As used herein the terms “direction”, “orientation” and “polarity” of a magnetic field interchangeably refer to poles of the magnet. The north pole of a magnet is the pole that, when the magnet is freely suspended, points towards the Earth's North Magnetic Pole in the Arctic. The poles of an electromagnet are determined by the direction of the current running through it.

As used herein the terms “magnetic moment” and “magnetic dipole moment” refer to a vector that characterizes the magnet's overall magnetic properties. For a bar magnet, the direction of the magnetic moment points from the magnet's south pole to its north pole, and the magnitude relates to how strong and how far apart these poles are.

According to some embodiments, there is further provided, a method for identifying a tube connector, the method comprising inserting a tube connector having at least one magnet into a tube connector receptacle, detecting at least one parameter of the magnet and identifying the tube connector based on the at least one detected parameter.

According to some embodiments, the method comprises identifying a change in the at least one parameter during the insertion of said tube connector into the tube connector receptacle. According to some embodiments, the method further comprises identifying a change in the at least one parameter during the revolving of the tube connector relative to the tube connector receptacle.

According to some embodiments, the method further comprises producing at least one signal based on the at least one magnetic parameter and/or on the identified tube connector. According to some embodiments, the at least one signal generated may serve as a trigger to activate/deactivate a medical device. Alternatively or additionally, the at least one signal may serve to influence an operation mode of the medical device.

In some embodiments, said method further comprises triggering activation of a medical device based on the identification of the tube connector. Additionally or alternatively, the method further comprises triggering a mode of operation of the medical device based on the identification of the tube connector.

According to some embodiments, there is further provided a method which includes forming a tube connector; and applying at least one magnet onto the tube connector, such that a tube connection system can identify at least one parameter of the at least one magnet. According to some embodiments, the at least one magnet may be applied onto the tube connector, such that the tube connection system can identify recurring changes in the at least one parameter during insertion of the tube connector into a tube connector receptacle. Additionally or alternatively, the at least one magnet may be applied onto the tube connector, such that the tube connection system can identify recurring changes in the at least one parameter during insertion of the tube connector into a tube connector receptacle.

According to some embodiments, applying the at least one magnet comprises attaching, molding and/or embedding the magnet onto the connector.

According to some embodiments, the at least one magnet may be applied on an outer wall of the tube connector. According to some embodiments, the at least one magnet may be applied on an end face of the tube connector.

According to some embodiments, applying the at least one magnet comprises applying at least two magnets on same or different circumferential and/or longitudinal axes of the tube connector.

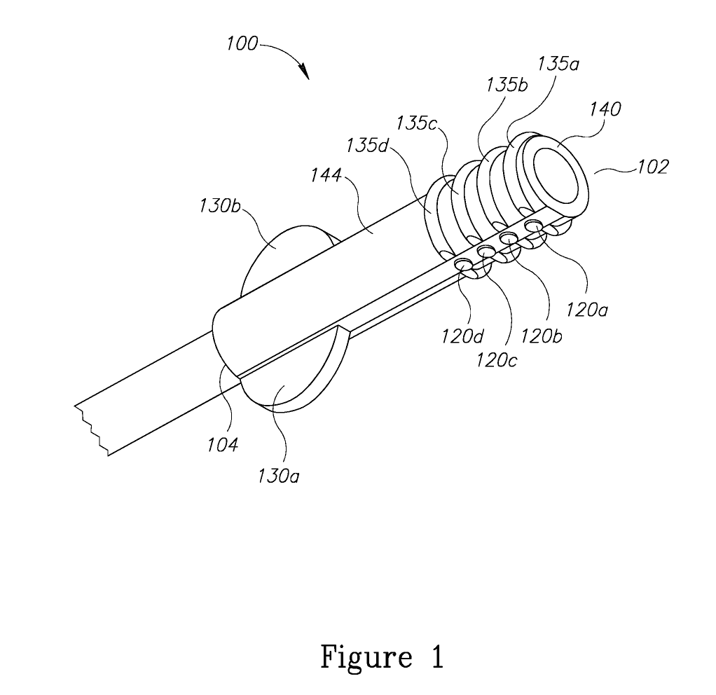

Reference is now made to FIG. 1, which schematically illustrates a perspective view of an exemplary tube connector, according to some embodiments.

The connecter, here exemplified as connector 100, may include two ends: a tube end 102, which is the end that may be connected to a tube or any other suitable constituent; and a device end 104, which is the end that may be used to connect the connector to a device/instrument. Tube connector 100 has an elongated cylindrical-like shape; however other suitable shapes are also applicable. Tube connector 100 has four magnets 120a-d, on an outer wall 144 of tube connector 100. Magnets 120a-d may be the same or different with regards to their magnetic characteristic (such as, but not limited to, magnetic field strength, orientation, flux density, etc.). Connector 100 is exemplified as having four magnets, however as understood from embodiments herein, different numbers of magnets are also applicable, such as 1, 2, 3, 5 magnets.

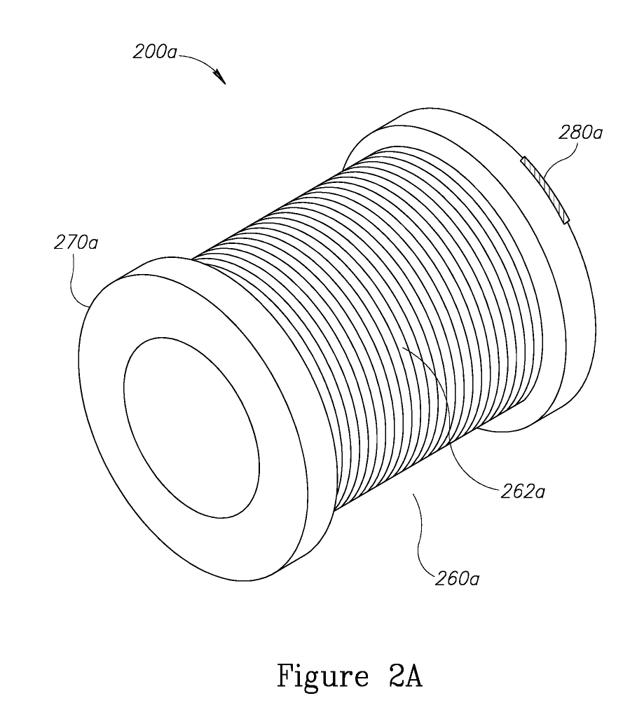

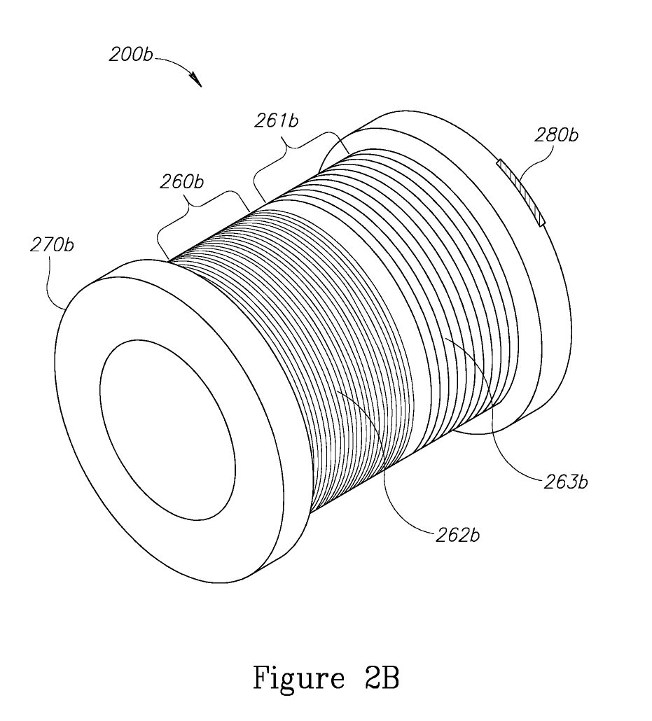

Tube end 102 of connector 100 includes gripping wings 130a-b (such gripping wings may have any shape or form and may also be absent from the connector). Tube connector 100 further includes ribs 135a-d at the outer surface of tube connector 100 in close proximity to the device end 104 of connector 100 and may be used to secure connector 100 to a matching tube connector receptacle (such as tube connector receptacle 200a/b illustrated in FIG. 2) and/or to avoid direct contact between magnets 120a-d and tube connector receptacle 200. Device end 104 of connector 100 has an end face 140 having a circular, annular shape. Tube connector 100, is shown attached to a fluid sampling tube 200, which may be a part of a sampling line (not shown). It is understood by the skilled in the art that the sampling line may also include additional elements such as, but not limited to, a filter housing, an oral/nasal cannula and/or any other element.

According to some embodiments, tube connector 100 may be a radial connector, for instance a luer connector, such as a female and/or male luer connector (as illustrated in FIG. 1). However other connectors, such as non-radial push-in connectors also fall under the scope of the disclosure.

FIG. 2A schematically illustrates a perspective view of a tube connector receptacle 200a configured to receive a tube connector such as for example tube connector 100 of FIG. 1. Tube connector receptacle 200a comprises a coil, such as coil 260a. Coil 260a includes a wire 262a wound around a hollow core 270a configured to receive tube connector 100. Coil 260a is illustrated as having 24 turns around the core. However, it is understood by one of ordinary skill in the art that the number of turns may vary and that the strength of the current and the magnetic field induced in the coil is stronger when the number of turns increase. According to some embodiments hollow core 270a is made of a ferromagnetic material, which enhances the strength of the induced EMF. Insertion (and withdrawal) of a tube connector, such as tube connector 100 comprising magnets, such as magnets 120a-d, generates a current in coil 260a.

Additionally, or alternatively revolving tube connector 100 relative to tube connector receptacle 200a generates a current in coil 260a. The direction of the current in coil 260a depends on the orientation of the magnet(s) (such as magnets 120a-d) on tube connector 100 relative to coil 260a and whether connector 100 is inserted or withdrawn. Tube connector receptacle 200a is normally part of a medical device, such as for example a capnograph (not shown). However, according to some embodiments, tube connector receptacle 200a may be a separate unit configured to generate an interface between tube connector 100 and the medical device such as for example a fluid flow connection between tube connector 100 and the medical device.

Optionally, tube connector receptacle 200a further includes at least one magnet, 280a. Magnet 280a may have an opposite magnetic moment than the magnet(s) on the corresponding tube connector, such as for example 120a-d of tube connector 100. Magnet 280a may assist the medical personnel in the insertion of the tube connector into tube connector receptacle 200a. According to some embodiments, magnet 280a is positioned at a distal end of tube connector receptacle 200a.

FIG. 2B schematically illustrates a perspective view of a tube connector receptacle 200b configured to receive a tube connector such as tube connector 100 of FIG. 1. Tube connector receptacle 200b comprises two coils 260b and 261b. Coils 260b and 261b include wires 262b and 263b wound around a hollow core 270b configured to receive tube connector 100. Coil 260b is illustrated as having wire 262b wound in more turns around hollow core 270b than coil 261b. Accordingly the strength of the current and the magnetic field induced in coil 260b is stronger than the strength of the current and the magnetic field induced in coil 261b. However, it is understood by one of ordinary skill in the art that the number of turns of wire 262b may be larger than the number of turns of wire 263b in coil 260b or that the number of turns of wires 262b and 263b may be identical in both coils 260b and 261b. According to some embodiments hollow core 270 is made of a ferromagnetic material, which enhances the strength of the induced EMF. Insertion (and withdrawal) of a tube connector, such as tube connector 100 comprising magnets, such as magnets 120a-d, generates a current in coils 260b and 261b. Additionally, or alternatively revolving tube connector 100 relative to tube receptacle 200b generates a current in coils 260b and 261b. The direction of the current in coils 260b and 261b depends on the orientation of the magnet(s) on tube connector 100 relative to coils 260b and 261b and whether connector 100 is inserted or withdrawn. Tube connector receptacle 200b is normally part of a medical device, such as for example a capnograph (not shown). However, according to some embodiments, tube connector receptacle 200b may be a separate unit configured to generate an interface between tube connector 100 and the medical device such as for example a fluid flow connection between tube connector 100 and the medical device.

Optionally, tube connector receptacle 200b further includes at least one magnet, 280b. Magnet 280b may have an opposite magnetic moment than the magnet(s) on the corresponding connector, such as for example 120a-d of tube connector 100. Magnet 280b may assist the medical personnel in the insertion of the tube connector into tube connector receptacle 200b. According to some embodiments, magnet 280b is positioned at a distal end of tube connector receptacle 200b.

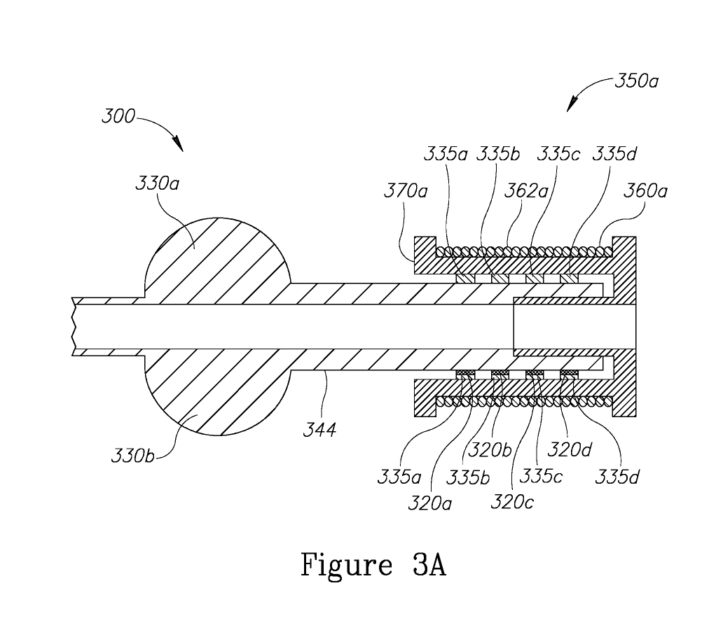

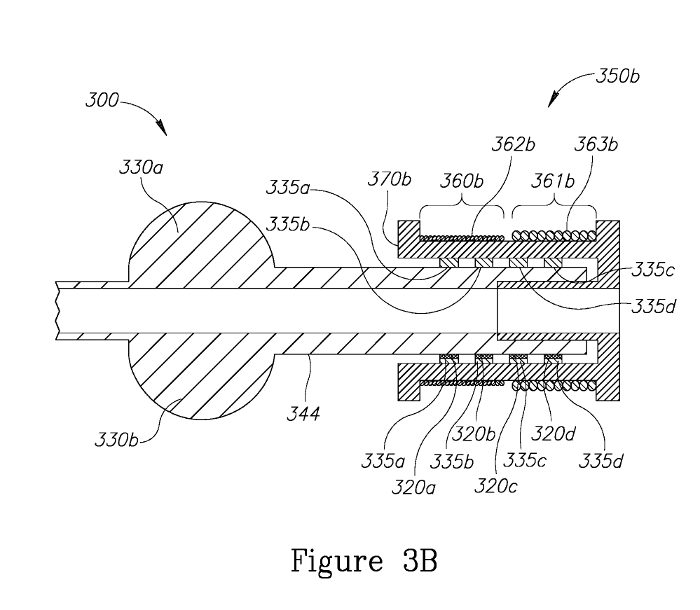

FIG. 3A schematically illustrates a section view of a tube connector, such as tube connector 300 inserted into a tube connector receptacle, such as tube connector receptacle 350a, according to some embodiments. For illustrative purposes tube connector 300 is similar to connector 100 illustrated above, however, any other connector described herein is likewise applicable. Tube connector 300 is exemplified as including four magnets 320a-d on an outer wall 344 of tube connector 300. Tube connector 300 also includes gripping wings 330a-b (such gripping wings may have any shape or form and may also be absent from the connector). Gripping wings 330a-b are configured to assist the medical personnel in firmly grasping tube connector 300 and inserting it into tube connector receptacle 350a. Magnets 320a-d are positioned such that insertion of tube connector 300 into tube connector receptacle 350a generates inductance in a coil such as coil 360a having wire 362a wound around hollow core 370a, of tube connector receptacle 350a. The inductance in coil 360a may be detected by a tube connector system as described in some embodiments.

It is further understood that the inductance generated in coil 360a depend on the magnetic characteristics of each of magnets 320a-d, their orientation on tube connector 300 relative to tube connector receptacle 350a, their orientation with respect to one another and the distance between their magnetic fields. According to some embodiments, the inductance generated in coil 360a is enhanced as additional magnets enter tube connector receptacle 350a. According to some embodiments, the inductance generated in coil 360a is nullified as additional magnets enter tube connector receptacle 350a. According to some embodiments, the inductance generated in coil 360a is reverted as additional magnets enter tube connector receptacle 350a.

It is further understood that the induction in the coil depends on the speed of insertion of the magnet. According to some embodiments, the tube connector receptacle may include insertion speed unifiers configured to level out the insertion speed of the tube connector such as tube connector 300 into a tube connector receptacle, such as tube connector receptacle 350a. According to some embodiments, suitable insertion speed unifiers may include threads, indents, ribs or any other elements on the tube connector or in the tube connector receptacle configured to generate a uniform insertion speed of the connector into the tube connector receptacle even when used by different users. According to some embodiments, tube connector 300 includes ribs 335a-d which may also serve as insertion speed unifiers.

According to some embodiments, when a radial connector is inserted into a tube connector receptacle including a coil, it may be necessary to revolve the connector relative to the receptacle in order for the connector to firmly connect. In such cases, revolving of the connector may also generate a current and cause inductance in the coil. For example if the tube connector includes a magnet(s) positioned such that the magnetic moment of the magnet(s) is perpendicular to the main axis (insertion axis) of the connector, revolving the connector will cause (maximum) inductance in the coil of the receptacle. If on the contrary the magnetic moment of the magnet is parallel to the insertion axis, revolving of the connector relative to the receptacle will not induce a current in the coil of the receptacle. It is understood by the skilled in the art that if the magnetic moment of the magnet is oriented in any angle between 0-90° relative to the insertion axis a current of a magnitude less than maximum will be induced. Suitable angles include but are not limited to 10, 20, 45, 60° relative to the insertion axis as well as any other suitable angle in the range of 0-90°.

It is further understood that the induction in the coil depends on the speed of the revolving of the tube connector relative to the receptacle. According to some embodiments, tube connector receptacle, such as tube connector receptacle 350a, may include insertion speed unifiers configured to level out the speed of revolving the tube connector such as tube connector 300 relative to the tube connector receptacle. According to some embodiments, suitable revolving speed unifiers may include threads, indents, ribs or any other elements, on the tube connector or in the receptacle, configured to generate a uniform revolving speed even when used by different users. According to some embodiments, ribs 335a-d may also serve as revolving speed unifiers. According to some embodiments, the insertion speed unifiers and the revolving speed unifiers may be the same elements on the tube connector or receptacle. According to some embodiments, different elements on either the tube connector or the receptacle serve as insertion speed unifiers and revolving speed unifiers.

FIG. 3B schematically illustrates a section view of a tube connector, such as tube connector 300 inserted into a tube connector receptacle, such as tube connector receptacle 350b, according to some embodiments. For illustrative purposes connector 300 is similar to connector 100 illustrated above, however, any other connector described herein is likewise applicable. Tube connector 300 is exemplified as including four magnets 320a-d on an outer wall 344 of tube connector 300. Tube connector 300 also includes gripping wings 330a-b (such gripping wings may have any shape or form and may also be absent from the connector). Gripping wings 330a-b are configured to assist the medical personnel in firmly grasping tube connector 300 and inserting it into tube connector receptacle 350b. Magnets 320a-d are positioned such that insertion of tube connector 300 into tube connector receptacle 350b generates inductance in coils 360b and 361b having wires 362b and 363b wound around hollow core 370b. The inductance in coils 360b and 361b may be detected by a tube connector system as described in some embodiments.

It is understood that the inductance generated in coils 360b and 361b depend on the magnetic characteristics of each of magnets 320a-d, their orientation on tube connector 300 relative to tube connector receptacle 350b, their orientation with respect to one another and the distance between their magnetic fields. According to some embodiments, the inductance generated in coils 360b and 361b is identical. According to some embodiments, the inductance generated in coils 360b and 361b is different. According to some embodiments, the inductance generated in coils 360b and 361b can be detected simultaneously and/or sequentially by the tube connector system. According to some embodiment, the inductance generated in each of coils 360b and 361b can be used to identify tube connector 300.

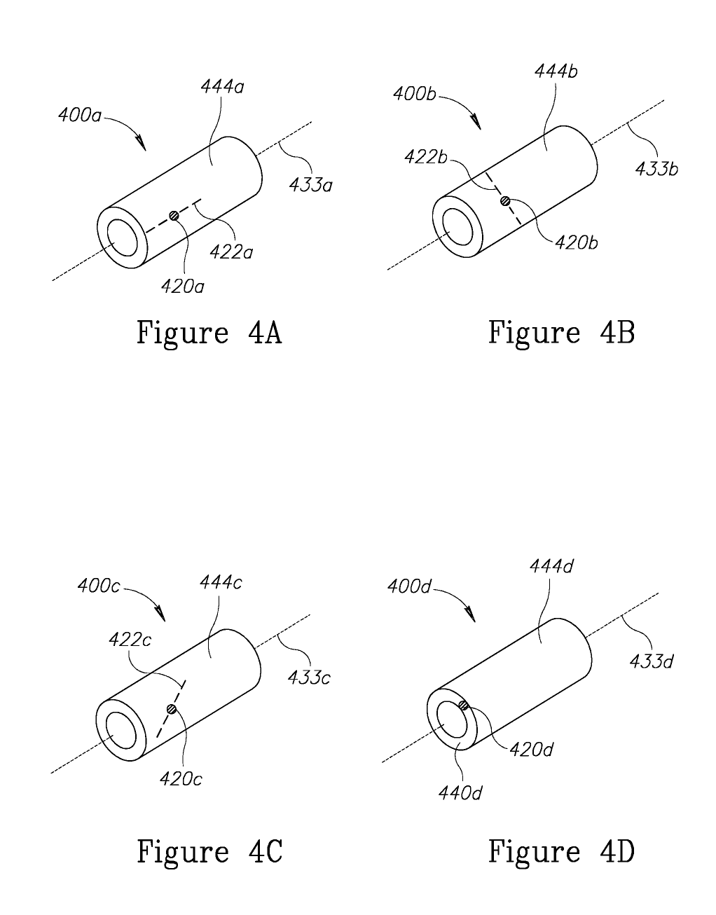

FIG. 4 schematically illustrates perspective views of tube connectors comprising a single magnet according to some embodiments. It is understood by the skilled in the art that the illustrated tube connectors are non-limiting examples and that additional configurations, not illustrated in the exemplary figures, fall under the scope of the disclosure. FIG. 4A, schematically illustrates a perspective view of a tube connector 400a including a single magnet 420a on an outer wall 444a of tube connector 400a. Magnet 420a are positioned such that the magnetic moment 422a of magnet 420a is parallel to a main axis 433a (insertion axis) of tube connector 400a. It is understood by one of ordinary skill in the art that inserting tube connector 400a will cause inductance in a coil of a tube connector receptacle, such as tube connector receptacle 200a. FIG. 4B, schematically illustrates a perspective view of a tube connector 400b including a single magnet on an outer wall 444b of tube connector 400b. Magnet 420b are positioned such that the magnetic moment 422b of magnet 420b is perpendicular to a main axis 433b (insertion axis) of tube connector 400b. It is understood by one of ordinary skill in the art that revolving tube connector 400b relative to a tube connector receptacle, such as tube connector receptacle 200a will cause inductance in the coil such as coil 260a. FIG. 4C, schematically illustrates a perspective view of a tube connector 400c including a single magnet 420c on an outer wall 444c of tube connector 400c. Magnet 420c is positioned such that the magnetic moment 422c of magnet 420c has an angle α (alpha) relative to main axis 433c (insertion axis) of connector 400c. It is understood by one of ordinary skill in the art that both insertion of tube connector 400c and revolving of connector 400c relative to a tube connector receptacle, such as tube connector receptacle 200a will cause inductance in the coil, such as coil 260a. FIG. 4D, schematically illustrates a perspective view of a tube connector 400d including a single magnet 420d positioned on an end face 440d of tube connector 400d. Magnet 420d is illustrated as covering only part of end-face 440d. However, according to some embodiments, magnet 420d may cover entire end face 440d. According to some embodiments magnet 420d may serve to assist the medical personnel in inserting tube connector 400d into a tube connector receptacle comprising a magnet having an opposite magnetic dipole moment.

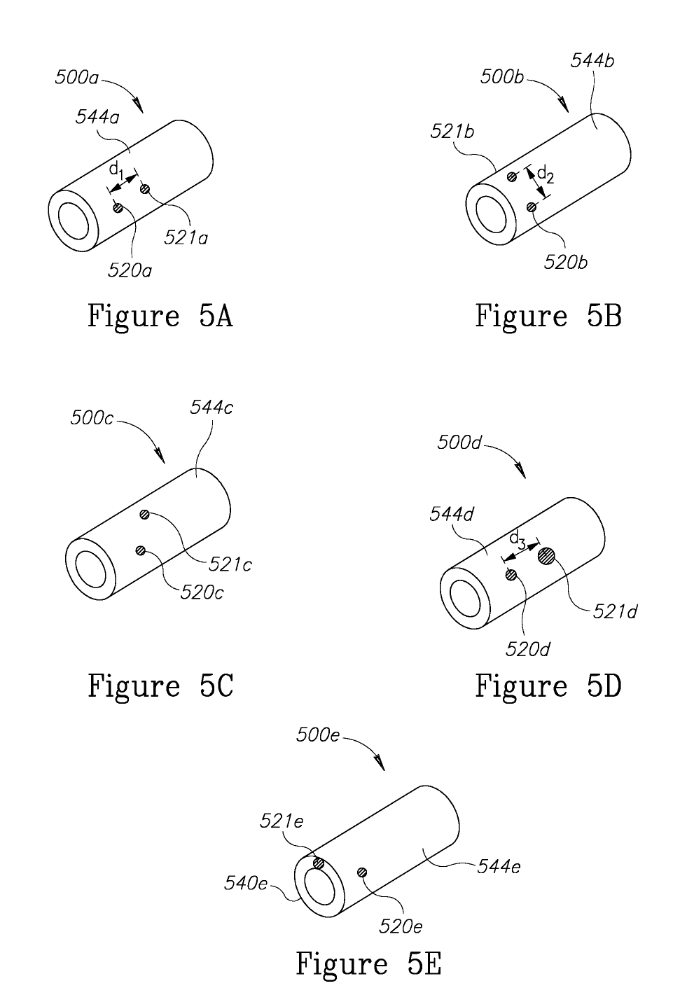

FIG. 5 schematically illustrates perspective views of tube connectors comprising two magnets according to some embodiments. It is understood by the skilled in the art that the illustrated tube connectors are non-limiting examples and that additional configurations, not illustrated in the exemplary figures, fall under the scope of the disclosure. FIG. 5A, schematically illustrates a perspective view of a tube connector 500a comprising two identical magnets 520a and 521a on an outer wall 544a of tube connector 500a. Magnets 520a and 521a are positioned at similar circumferential positions, but different longitudinal positions on tube connector 500a. According to some embodiments, the orientation of magnets 520a and 521a may be parallel. According to some embodiments, the orientation of magnets 520a and 521a may be antiparallel. According to some embodiments the orientation of magnets 520a and 521a may be in an angle β (beta) relative to one another. According to some embodiments, angle β (beta) may be any angle between 0-180°, such as but not limited to 45° or 125°. According to some embodiments, magnets 520a and 521a are positioned at a distance d1 from one another and have such magnetic properties that the magnetic fields of magnets 520a and 521a do not influence one another. Optionally, tube connector 500a includes a magnetic shielding material configured to shield off the respective magnetic fields of magnets 520a and 521a. According to some embodiments, tube connector 500a is made of a magnetic shielding material. According to some embodiments, tube connector 500a includes a magnetic shielding material molded on or otherwise attached to tube connector 500a between magnets 520a and 521a. FIG. 5B, schematically illustrates a perspective view of a tube connector 500b comprising two identical magnets 520b and 521b on an outer wall 544b of tube connector 500b. Magnets 520b and 521b are positioned at similar longitudinal positions, but different circumferential positions on tube connector 500b. According to some embodiments, the orientation of magnets 520b and 521b may be parallel. According to some embodiments, the orientation of magnets 520b and 521b may be antiparallel. According to some embodiments the orientation of magnets 520b and 521b may be in an angle β (beta) relative to one another. According to some embodiments, angle β (beta) may be any angle between 0-180°, such as but not limited to 45° or 125°. According to some embodiments, magnets 520b and 521b are positioned at a distance d2 from one another and have such magnetic properties that the magnetic fields of magnets 520b and 521b do not influence one another. Optionally, tube connector 500b includes a magnetic shielding material configured to shield off the respective magnetic fields of magnets 520b and 521b. According to some embodiments, tube connector 500b is made of a magnetic shielding material. According to some embodiments, tube connector 500b includes a magnetic shielding material molded on or otherwise attached to tube connector 500b between magnets 520b and 521b. FIG. 5C, schematically illustrates a perspective view of a tube connector 500c including two identical magnets 520c and 521c on an outer wall 544c of tube connector 500c. Magnets 520c and 521c may be positioned at different longitudinal and circumferential positions on tube connector 500c. According to some embodiments, the orientation of magnets 520c and 521c may be parallel. According to some embodiments, the orientation of magnets 520c and 521c may be antiparallel. According to some embodiments the orientation of magnets 520c and 521c may be in an angle β relative to one another. According to some embodiments, angle β may be any angle between 0-180°, such as but not limited to 45° or 125°. According to some embodiments, magnets 520c and 521c distanced from each other and have such magnetic properties that the magnetic fields of magnets 520c and 521c do not influence one another. Optionally, tube connector 500c includes a magnetic shielding material configured to shield off the respective magnetic fields of magnets 520c and 521c. According to some embodiments, tube connector 500c is made of a magnetic shielding material. According to some embodiments, tube connector 500c includes a magnetic shielding material molded on or otherwise attached to tube connector 500c between magnets 520c and 521c. FIG. 5D, schematically illustrates a perspective view of a tube connector 500d including magnets 520d and 521d on an outer wall 544d of tube connector 500d. Magnets 520d and 521d may differ in the strength of their magnetic field. According to some embodiments, magnet 520d may have a weaker magnetic field than magnet 521d. According to some embodiments, magnet 520d may have a stronger magnetic field than magnet 521d (not shown). Magnets 520d and 521d are here illustrated as being positioned at different longitudinal, but identical circumferential positions. However, it is understood by one of ordinary skill in the art that other positions of magnets 520d and 521d, such as those described above, fall under the scope of the disclosure. According to some embodiments, the orientation of magnets 520d and 521d may be parallel. According to some embodiments, the orientation of magnets 520d and 521d may be antiparallel. According to some embodiments the orientation of magnets 520d and 521d may be in an angle β relative to one another. According to some embodiments, angle β may be any angle between 0-180°, such as but not limited to 45° or 125°. According to some embodiments, magnets 520d and 521d are positioned at a distance d3 from one another and have such magnetic properties that the magnetic fields of magnets 520d and 521d do not influence one another. Optionally, tube connector 500d includes a magnetic shielding material configured to shield off the respective magnetic fields of magnets 520d and 521d. According to some embodiments, tube connector 500d is made of a magnetic shielding material. According to some embodiments, tube connector 500d includes a magnetic shielding material molded on or otherwise attached to tube connector 500d between magnets 520d and 521d. FIG. 5E, schematically illustrates a perspective view of a tube connector 500e comprising two magnets, 520e on an outer wall 544e of tube connector 500e and 521e on an end face 540e of tube connector 500e.

The tube connectors in FIG. 5 all include two magnets. However as taught herein, the connectors may include more than two magnets. The configuration of the more than two magnets may be any of the configurations illustrated herein or combinations of these configurations, all possibilities fall under the scope of the disclosure.

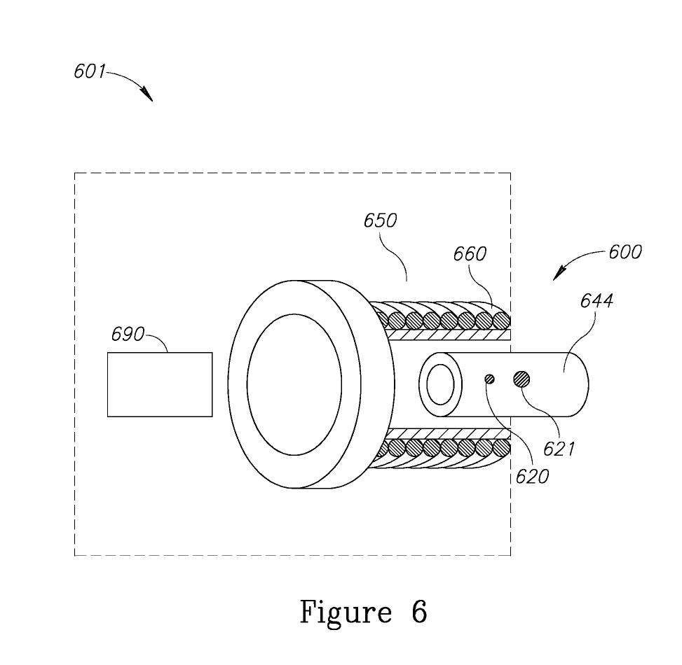

FIG. 6 schematically illustrates a perspective view of a connector having a magnet disposed on an outer wall thereof and a block diagram of a tube connection system, according to some embodiments. As essentially described hereinabove, connector 600 may include at least one magnet, here illustrated as magnets 620 and 621 on an outer wall 644 of connector 600; however connector 600 may be any of the connectors described herein. According to some embodiments, tube connector system 601 is configured to identify, authenticate, and/or specify tube connector 600. Tube connection system 601 includes a tube connector receptacle 650, and one or more detectors, such as detector 690 configured to detect at least one parameter of magnets 620 and 621. Tube connector receptacle 650 includes a coil 660. According to some embodiments, insertion and/or rotation of tube connector 600 into tube connector receptacle 650 generates a current in coil 660. According to some embodiments, detector 690 is configured to detect the current in coil 660. According to some embodiments, insertion and/or rotation of tube connector 600 into tube connector receptacle 650 induces an EMF in coil 660. According to some embodiments, detector 690 is configured to detect the characteristics of the induced EMF of coil 660.

Alternatively, tube connector receptacle includes more than one coil (similarly to tube connector receptacle 200b, which includes two coils 260b and 261b and tube connector receptacle 350b, which includes coils 360b and 361b). According to some embodiments, insertion and/or rotation of a tube connector into a tube connector receptacle including more than one coil generates a current in the more than one coil. According to some embodiments, the current generated in each of the coils is identical. According to some embodiments, the current generated in each of the coils is different. According to some embodiments, the detector is configured to detect the current in each of the more than one coil simultaneously and/or sequentially. According to some embodiments, insertion and/or rotation of a tube connector into a tube connector receptacle including more than one coil induces an EMF in the each of the coils. According to some embodiments, the detector is configured to detect the characteristics of the induced EMF in each of the coils.

According to some embodiments, there is further provided, a method for identifying a tube connector, the method comprising inserting the tube connector into a tube connector receptacle, detecting at least one parameter of at least one magnet positioned on the tube connector and identifying the tube connector based on the at least one detected parameter.

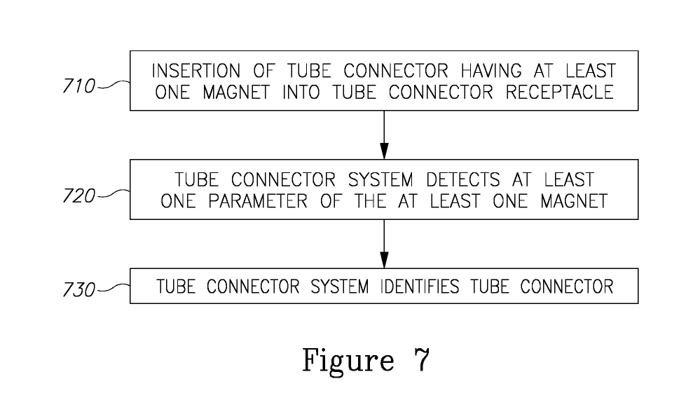

FIG. 7 is an illustrative flowchart of identification of a tube connector, according to some embodiments. In step 710, a tube connector having at least one magnet, such as for example, but not limited to, tube connector 100, is inserted into a tube connector receptacle, such as for example, but not limited to, tube connector receptacle 200. In step 720 at least one parameter of the at least one magnet is detected by a tube connector system. In step 730, the tube connector is identified based on the at least one detected parameter. For example, insertion of tube connector 100 into tube connector receptacle 200 generates inductance in coil 260 of tube connector 200. The inductance generated can then be detected by a detector in the tube connection system configured to identify the tube connector (such as tube connection system 601). It is understood by one of ordinary skill in the art that the strength and/or the direction of the current induced in the coil may vary when magnets of different strength and/or orientation are inserted and that such differences can be utilized to differentiate between different connectors and consequently to identify the tubes or other constituents connected thereto.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude or rule out the presence or addition of one or more other features, integers, steps, operations, elements, components, or groups thereof.

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

What is claimed is:

1. A tube connector, comprising at least one magnet, wherein said at least one magnet is arranged such that a tube connection system can identify at least one parameter of said at least one magnet.

2. The tube connector of claim 1, wherein said at least one parameter is selected from the group consisting of inductance, flux, strength of magnetic field and polarity.

3. The tube connector of claim 1, wherein said at least one magnet is attached to, embedded in or molded on an outer wall of said tube connecter.

4. The tube connector of claim 1, comprising at least two magnets.

5. The tube connector of claim 4, wherein said at least two magnets are identical or different.

6. The tube connector of claim 4, wherein said at least two magnets are arranged in a same or different circumferential axis of said connecter.

7. The tube connector of claim 4, wherein said at least two magnets are arranged in a same or different longitudinal axis of said connecter.

8. The tube connector of claim 1, wherein said tube connection system is further configured to identify recurring changes in said at least one parameter during the insertion of said tube connector into a tube connector receptacle.

9. The tube connector of claim 1, wherein said tube connection system is further configured to identify recurring changes in said at least one parameter during the revolving of said tube connector relative to a tube connector receptacle.

10. The tube connector of claim 1, wherein said at least one parameter of said at least one magnet is indicative of a type of said tube connector.

11. The tube connector of claim 1, wherein said at least one parameter of said at least one magnet is indicative of a preferred mode of operation of said tube connector.

12. The tube connector of claim 1, wherein said connector is configured to connect to a medical device.

13. The tube connector of claim 12, wherein when said at least one parameter is identified, said medical device is actuated.

14. The tube connector of claim 12, wherein when said at least one parameter is identified, said medical device is actuated in a preferred mode of operation.

15. The tube connector of claim 12, wherein said at least one magnet eases proper connection of said connecter to said medical device.

16. The tube connector of claim 1, wherein said connecter is attached to a fluid sampling tube.

17. A method comprising:
forming a tube connector; and
applying at least one magnet onto the tube connector, such that a tube connection system can identify at least one parameter of the at least one magnet.

18. The method of claim 17, wherein applying comprises attaching, molding and embedding the magnet onto the connector.

19. The method of claim 17, wherein the at least one magnet is applied on an outer wall of the tube connector.

20. The method of claim 17, wherein applying the at least one magnet comprises applying at least two magnets on same or different circumferential and/or longitudinal axes of the tube connector.
